(19) United States
(12) Patent Application Publication
(10) Pub. No.: US 2010/0096333 A1
(43) Pub. Date: Apr. 22, 2010

(54) Method and Apparatus for Removing Metals from Roof Top Storm Water Runoff

(76) Inventors: Mark E. Foreman, Santa Barbara, CA (US); Richard E. Kirts, Oxnard, CA (US); Gary D. Anguiano, Oxnard, CA (US)

Correspondence Address: NAVAIRWD COUNSEL GROUP, 575 I Ave, Suite 1, BUILDING 36, ROOM 2308, POINT MUGU, CA, 93042-5049, US

(21) Appl. No.: 12/256,031

(22) Filed: Oct. 22, 2008

(51) Int. Cl. C02F 1/42

(52) U.S. Cl. 210/679; 210/170.03; 210/681; 210/290; 210/688

(57) ABSTRACT

A method and apparatus for the removal of metals and cleanup of roof top storm water runoff comprising a drum structure which includes at least two media beds for filtering the storm water runoff. The first media bed filters out particles of toxic metals and metal ions are absorbed on the media material in the first media bed. The storm water then runs through the second media bed which filters out additional particles of metal and metal ions are absorbed on the media material in the second media bed resulting in a clean effluent

### BACKGROUND OF THE INVENTION

1. Field of the Invention

The present invention relates generally to the removal of metals and cleanup of roof top storm water runoff, wastewater from ship bilge and the like. More specifically, the present invention relates to a method and apparatus and the materials associated with the method and apparatus for the removal of metals and cleanup of roof top storm water runoff, wastewater from ship bilge and the like.

2. Description of the Prior Art

Metal contamination of storm water from roof tops at military facilities, bilge water from ship from military vessels and other waste water streams take two basic forms: particles of metal and ions of metal.

Analysis of storm water runoff from a military industrial activity indicates that 40% to 60% of mass of most metals is represented by particles smaller than 5 microns in size. Typically 10% to 15% of the mass of metals is in dissolved (ionic) form. An exception is copper., which is about 50% in ionic form.

Of special concern to the military are high concentrations of zinc and copper in storm water runoff and the like. These metals must be removed from the water runoff if the military is going to comply with Federal, state and local water discharge regulations. In particular, the Navy needs to meet the toxic removal requirements of Order R9-2002-0169 issued by the California Regional Water Quality Control Board, San Diego, Calif. Region. This order requires storm water runoff from Navy industrial activities in the San Diego area to pass specifications for toxicity and, in particular sets new standards for levels of copper and zinc in storm water runoff.

Accordingly, there is a need to remove toxic metals from a wastewater stream by a process or method and an apparatus which (1) effectively filters or otherwise removes very small particles and also (2) removes ions from wastewater solutions.

### SUMMARY OF THE INVENTION

The present invention overcomes some of the difficulties of the past including those mentioned above in that it comprises a relatively simple but highly efficient method and apparatus for filtering or otherwise removes very small particles of toxic metals and also (2) removes ions of these toxic metals from storm water solutions.

The preferred embodiment of the present invention comprises drum structure for receiving storm water runoff from a roof's downspout. The interior of the drum structure has two filtration media contained within the structure for filtering out toxic metal particles from the storm water runoff and removing metal ions from the runoff. The media used in the preferred embodiment comprise one foot one inch bed of bone char and a bed of activated alumina which is one foot eight inches thick. The lid for the drum includes a mesh strainer basket which removes large particles of these toxic metals from the storm water runoff.

Positioned under the activated alumina within the drum structure is a bed of river stone. Embedded within the river stone are a pair of slotted drainage pipes which are slanted at approximately two degrees to allow for drainage of clean effluent from the drum structure.

### BRIEF DESCRIPTION OF THE DRAWINGS

FIG. 1 is a simplified embodiment illustrating the materials utilized by the present invention;

FIG. 2 is a view illustrating an embodiment of the invention being used to treat storm water runoff from the roof top of a military facility;

FIG. 3 illustrates a view in section of a preferred embodiment of the present invention for removing metals and metal ions from roof top storm water runoff; and

FIG. 4 is a view illustrating the bottom portion of the treatment apparatus of FIG. 2 including the drainage pipes.

### DETAILED DESCRIPTION OF A PREFERRED EMBODIMENT

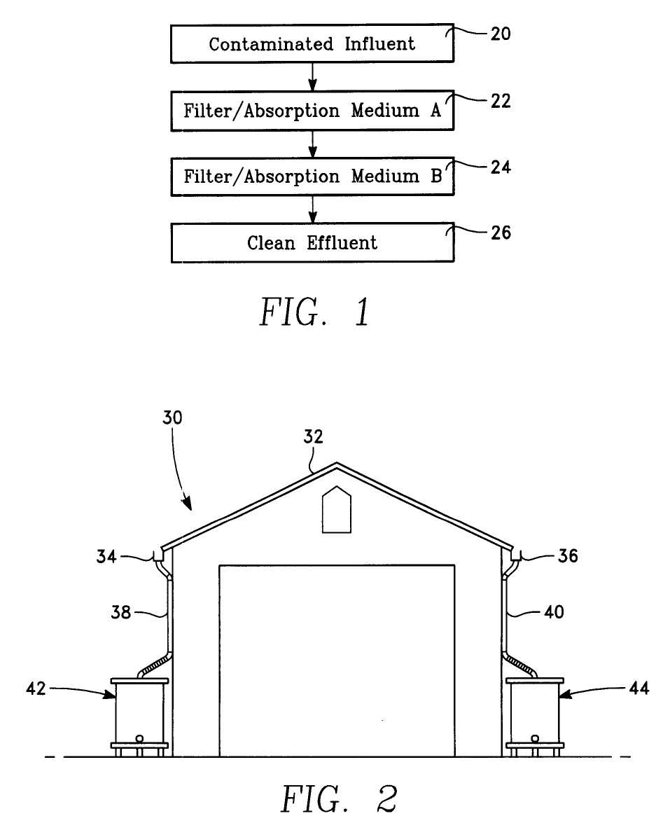

Referring to FIG. 1 there is shown a block diagram illustrating an embodiment of the invention which is used to remove toxic metals (in both solid and dissolved form) from roof top storm water runoff. The invention of FIG. 1 may also be used to remove contaminant metals from ship bilge and compensating ballast water, from plating shop wastewater, from pipe cleaning process wastewater, and from other wastewater streams containing solid and dissolved metals.

Rooftop contaminated wastewater (block 20) contaminated with metals, e.g. lead, zinc and copper, in solid and dissolved form enters media bed A (block 22). As the wastewater runs through the media bed A, particles of metals are filtered out of the wastewater and metal ions are absorbed on the media material in bed A (block 22). After exiting media bed A, the wastewater runs a second media bed, media bed B (block 24). As wastewater runs through media bed B, additional particles of metal are filtered out of the wastewater and metal ions are absorbed on the media material in bed B (block 24). The result of the absorption process is a clean effluent (block 26). In some applications the media materials in beds A and B may be mixed together in a single bed.

Two or more different types of media are used to remove metals from wastewater since each media type is generally better at removing one specie of metal than another specie of metal. For example, media A may be effective at removing copper, but not very effective at removing zinc. However, media B may be effective at removing zinc, but not very effective at removing copper.

In another situation, media A may be effective at removing two different species of metal but not a third species of metal. Media B is then used to remove a third specie of metal. For example, certain types of activated alumina when used as media A are very effective at removing copper and zinc form wastewater. However, activated alumina adds aluminum to the wastewater stream. A second layer of media, such as manganese green sand is then used to remove the aluminum added the stream from the wastewater being treated.

A mixture of materials are used in the preferred embodiment of the invention to remove environmentally harmful metals including zinc, copper, and other metal particulate and ions from roof top storm water runoff. Materials which were found to be effective in removing these metals from roof top storm water runoff are activated alumina, iron coated activated alumina, bone char and manganese greensand. However, it was also found that layers of various materials perform substantially better at removing metals from storm water runoff than a single layer of activated alumina, iron coated activated alumina, bone char or manganese greensand. The surface structure and surface electrical charge of these materials are such that they produce very high metal removal efficiencies.

Activated alumina is manufactured by a process that produces a very large surface area on each particle of alumina. The large surface area is manifested by a very rough surface characterized by small pits, voids and other surface irregularities. These surface irregularities are very effective at capturing small metal particles that impinge on the surface of activated alumina. Further, the surface of activated alumina has a net negative electrical charge which results in positively charged ions, such as metals attaching themselves to activated alumina.

Not all positively charged ions attach themselves to the activated alumina. Ion size and shape also effect which metals attach themselves to activated alumina. It has been found that sodium, calcium, potassium and most other metal ions in seawater will not absorb onto the materials such as activated alumina in significant quantities. This finding indicates that there is a long media life in seawater applications in these materials.

For special applications, activated alumina is coated with other chemical compounds. One such coating is iron sulfate which when combined with activated alumina is very effective at removing copper.

Bone char is fabricated from ground slaughter house bones heated in the absence of oxygen. The bone char is then treated with steam to increase its porisity and surface area.

As metal bearing roof top storm water runoff flows through the media beds A and B, particles of the metals are trapped on the surface of the beds or on the particles of the media. Metal ions attach themselves to the particles of the media A and B.

Referring to FIG. 2, there is shown a military facility such as fabrication building, ammunition or parts storage building, or test facility 30 which includes a roof top 32. Metals in storm water runoff from the roof top 32 of facility 30 pose a serious threat to the health of marine organisms. Of special concern are the presence of excessive amounts of copper and zinc in the roof top storm water runoff.

Measurements of storm water runoff at a variety of military building at various U.S. Naval Installations have shown that there are extremely high levels. At one Navy installation, measurements of copper concentrations ranged from 37 ppb to 1670 ppb with an average concentration value of 322 ppb in storm water runoff. Measurements of zinc concentration at this installation ranged from 168 ppb to 7800 ppb with an average concentration value of 1570 ppb.

At a second Navy installation, measurements of copper concentrations ranged from 12 ppb to 316 ppb with an average concentration value of 106 ppb in storm water runoff. Measurements of zinc concentration at this installation ranged from 682 ppb to 8830 ppb with an average concentration value of 3069 ppb. At the second Navy Installation, the roof top storm water runoff was identified as excessive of zinc.

Ideally and to comply the San Diego area regulations relating to metal toxicity the concentration of zinc within storm water runoff needs to be less than 117 micrograms/liter which 117 parts per billion. The concentration of copper within needs to be less than 63.5 micrograms per liter which is 63.5 parts per million to comply with these regulations.

Storm water runoff from roof top 32 which is slanted downward flows along the roof top 32 to a pair of guiders 34 and 36 located on each side of building 30. The storm water entering guiders 34 and 36 includes toxic metals which must be removed prior to the water being discharged in municipal owned water system, river, lake or the ocean. One end of a downspout 38 located on the left side of building 30 is connected to guider 34 and the opposite end of downspout 38 is connected to a storm water roof top runoff purification apparatus 42 which is used to remove toxic from the storm water runoff from roof top 32 of building 30. In a like manner, one end of a downspout 40 located on the right side of building 30 is connected to guider 36 and the opposite end of downspout 40 is connected to apparatus 44 which is also used to remove toxic from the storm water runoff from roof top 32 of building 30.

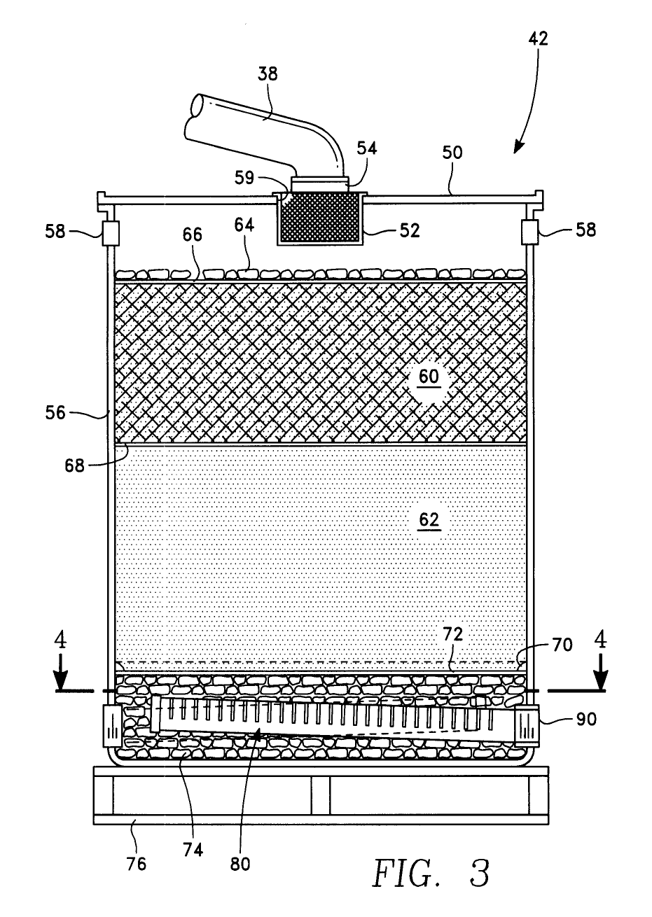

Referring to FIGS. 2 and 3, FIG. 3 shows a detailed view of the interior of water purification apparatus/tank 42, which is identical to apparatus 44. Only water purification apparatus 42 will be discussed in detailed at this time. Apparatus/tank 42 is configured as a drum like structure which has an overall diameter of approximately three feet and an overall height of four feet. In this configuration apparatus/tank 42 is capable of removing toxic metals from storm water runoff at a rate of 12 to 20 gallons per minute.

Apparatus/tank 42 has a lid 50 which is secured to the upper end of sidewall 56 by four equally spaced threaded inserts, not shown. There are also two equally spaced apart adapters 58 positioned at the upper end of sidewall 56. Each adapter 58 comprises a 1½″ PVC female thread which is drilled thru sidewall 56 and cemented to sidewall 56 of the tank. These can be used to connect a hose to the tank 42 allowing excess water to drain from the tank 42.

There is a centrally located seven inch diameter opening 59 in the lid 50 thru which storm water passes into apparatus 42 from the down spot 38. Positioned within opening 59 of lid 50 is a mesh strainer basket 52 which extends downward into the interior of tank 52. The mesh strainer basket 52 is used to remove large particles of toxic metals such as copper and zinc from the incoming storm water runoff stream. A metal strap 54 is used to secure the lower end of downspout 54 which is fabricated from a flexible material such as rubber to the lid 50 of tank 52.

Positioned below strainer basket 52 is a ¼″ layer of river stone 64 which is washed and is a thinly spread layer. The river stone 50 rest on a first layer of a geotextile monofilament material 66. Directly below the geotextile monofilament material 66 is a one foot one inch bed of bone char 60. The bed of bone char 60 rest on a second layer of the geotextile monofilament material 68. Positioned directly below the second layer of the geotextile monofilament material 68 is a bed of activated alumina 62. The bed of activated alumina 62 is one foot eight inches thick. The bed of activated alumina 62 and the bed of bone char 60 are used to remove particles of metal and ions of metal from the storm water runoff passing through tank 42.

Positioned below the bed of activated alumina 62 is a third layer of the geotextile material 72 upon which the bed of activated alumina 62 rest. There is also a continuous bead of a foam insulating spray 70 placed above the geotextile material 72 around the circumference of the tank interior. Positioned below the bed of activated alumina 62 is a bed of river stone 74 which has a thickness of seven inches. The water purification apparatus/tank 42 rest on a water resistant pallet 76.

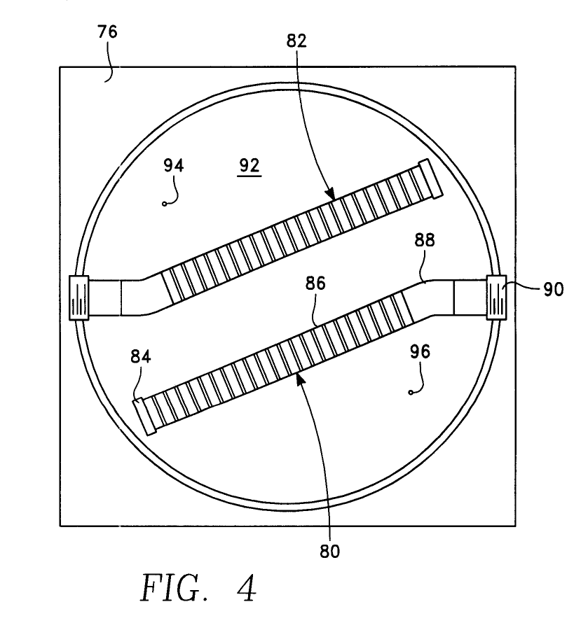

Referring to FIGS. 3 and 4, embedded the river stone are two drainage pipes 80 and 82. The two drainage pipes 80 and 82 are parallel to each other and spaced apart by about 22.5°. The following discussion is with respect to drainage pipe 80 only since the drainage pipes 80 and 82 are identical. Drainage pipes 80 and 82 which receive storm water which is almost metal contaminant free are sloped at approximately two percent. This two percent slope insures complete drainage of the storm water entering the drainage pipes 80 and 82 through the bed of river stone 74.

As shown in FIG. 3, drainage pipe 80 includes a 3″ PVC CAP 84 at the end of the drainage pipe within the interior of tank 42, a 3″ slotted PVC pipe section 86, and a 31″ PVC elbow section 88 which the user adjust to achieve the 2% drainage slope shown in FIG. 3. Positioned within the sidewall 56 at the bottom end of tank 42 is 3″ PVC female threaded pipe section 90 which is used to connect drainage pipe 80 to an external hose (not shown). The external hose can then used to transport clean effluent to city water system, a river or the like. The slotted section 86 of drainage pipe 80 allows clean storm water runoff to exit the tank 42. The bottom portion 92 of tank 42 has a pair of ⅛″ drainage holes located therein to allow for minimal drainage when required.

The following Tables illustrate the results of test which the Navy performed to remove toxic metals from storm water runoff. In the Tables set forth below the method used to test the storm water runoff is EPA 200.7 and the term ND means the concentration is below detection limits. The data was obtained using a combination of bone char over iron coated activated alumina.

TABLE I

| Metal | Influent | Effluent | Units | Limit |
|---|---|---|---|---|
| Aluminum | 1.4 | 0.084 | Mg/L | 0.750 |
| Cadmium | 0.039 | ND | Mg/L | 0.0159 |
| Chromium | 0.006 | ND | Mg/L | 0.020 |
| Copper | 0.994 | 0.062 | Mg/L | 0.064 |
| Iron | 1.92 | 0.125 | Mg/L | 1.0 |
| Lead | 0.182 | 0.005 | Mg/L | 0.082 |
| Zinc | 1.62 | 0.066 | Mg/L | 0.117 |

TABLE II

| Metal | Influent | Effluent | Units | Limit |
|---|---|---|---|---|
| Aluminum | 0.695 | 0.087 | Mg/L | 0.750 |
| Cadmium | 0.033 | ND | Mg/L | 0.0159 |
| Chromium | ND | ND | Mg/L | 0.020 |
| Copper | 0.938 | 0.056 | Mg/L | 0.064 |
| Iron | 1.95 | 0.136 | Mg/L | 1.0 |
| Lead | 0.101 | 0.005 | Mg/L | 0.082 |
| Zinc | 2.10 | 0.069 | Mg/L | 0.117 |

The following tables illustrate acute toxic result data

TABLE III

| Percent Effluent | Percent Survival |
|---|---|
| 100 | 97.5 |
| 50 | 100 |
| 25 | 100 |
| 12.5 | 100 |
| 6.25 | 100 |
| Control | 100 |

TABLE IV

| Percent Effluent | Percent Survival |
|---|---|
| 100 | 100 |
| 50 | 100 |
| 25 | 97.5 |
| 12.5 | 97.5 |
| 6.25 | 100 |
| Control | 100 |

Full scale testing of the water purification apparatus/tank 42 to remove copper and zinc from storm water runoff are presented in the following Table.

TABLE V

| | First Flush | | First Flush | |
|---|---|---|---|---|
| | Influent/ | | Influent/ | |
| | Effluent | Cu % | Effluent | Zn % |
| Date | Cu(μg/l) | Removal | Cu(μg/l) | Removal |
| Feb. 18, 2007 | 307/63 | 79 | 1170/180 | 85 |
| Feb. 22, 2007 | 143/29 | 80 | 572/102 | 82 |
| Feb. 27, 2007 | 356/34 | 91 | 1870/167 | 91 |
| Mar. 22, 2007 | 335/81 | 76 | 928/222 | 76 |
| Apr. 20, 2007 | 342/88 | 74 | 1260/251 | 80 |

Full scale Demonstration 96 hour Acute Toxicity Results are presented in the following Table.

TABLE VI

| | Acute Toxicity Test | Requirements |
|---|---|---|
| NRRC Acute Toxicity 90% | Survival 50% | 70% Survival |
| Test Requirements | of the time | 90% of the time |
| Full Scale NRRC Acute | 90% Survival 100% | 70% Survival |
| Toxicity Results for | of the time | 100% of the time |
| Five Test Conducted | | |
| From Feb. 18, 2007 to | | |
| Apr. 20, 2007 | | |

The following Table presents copper and zinc removal results for a 12 to 20 gallon per minute storm water roof top purification apparatus 42 (FIG. 3) for a combination of bone char over iron coated activated alumina at the Navy Base in Norfolk, Va.

TABLE VII

| | Oct. 22, 2007 | Oct. 22, 2007 | Nov. 13, 2007 | Nov. 13, 2007 | Apr. 21, 2008 | Apr. 21, 2008 |
|---|---|---|---|---|---|---|
| Location | Cu(μg/l) | Cu(μg/l) | Cu(μg/l) | Cu(μg/l) | Cu(μg/l) | Cu(μg/l) |
| V88 SE | 156 | 2700 | 176 | 3630 | 30.9 | 682 |
| Influent | | | | | | |
| V88 SE | <5 | <5 | <5 | <5 | <2 | 2.9 |
| Effluent | | | | | | |
| V88 NW | 81 | 1080 | 316 | 8830 | 31.6 | 1550 |
| Influent | | | | | | |
| V88 NW | <5 | <5 | <5 | <5 | <2 | 3.8 |
| Effluent | | | | | | |
| V88 W Fence | | | 42 | 5090 | 11.7 | 991 |
| Influent | | | | | | |
| V88 W Fence | | | <5 | <5 | <2 | 8.1 |
| Effluent | | | | | | |

At this time it should be noted that the following combination adsorption materials are useful in the preferred embodiment of the storm water roof top runoff purification apparatus 42 illustrated in FIG. 3.
1. Bone char and aluminum oxide coated with an iron sulfide (Alcan Aluminum Corporation's product FS-50 or equivalent).
2. Aluminum oxide (Alcan Aluminum Corporation's product FS-50 or equivalent).
3. Bone char, aluminum oxide, and manganese green sand. These combinations can be used as one layer of material over another layer of material or a mixture of materials. Mixing the media lowers metal removal effectiveness by about ten percent.

What is claimed is:

1. A water purification apparatus for removing toxic metals and metal ions from storm water runoff from a roof top comprising:
(a) a drum structure having an interior and a lid attached to an upper end thereof, wherein the lid of said drum structure includes a centrally located opening for receiving one end of a downspout which transports said storm water runoff from said roof top;
(b) a strainer basket positioned within the opening in the lid of said drum structure to receive the storm runoff from said roof top, wherein said strainer basket removes large particles of said toxic metals from the storm water runoff entering said drum structure;
(c) a first layer of river stone positioned within the interior of said drum structure below the lid of said drum structure;
(d) first and second absorption beds consisting of first and second layers of absorbent materials stacked one on top of another within the interior of said drum structure below said first layer of river stone, wherein said first and second absorbent materials remove fine particles of said toxic materials and said metal ions from said storm water runoff to provide clean water
(e) a second layer of river stone positioned below said first and second layers of absorbent materials to receive the clean water from said first and second layers of absorbent materials; and
(f) a pair of slotted drainage pipes positioned parallel to one another within said second layer of river stone, wherein said pair of slotted drainage pipes are slopped downward to allow for drainage of said clean water from said drum structure.

2. The water purification apparatus of claim 1 wherein said drum structure has a diameter of three feet and a height of four feet and is capable of removing said toxic metals from said storm water runoff at a rate of 12 to 20 gallons per minute.

3. The water purification apparatus of claim 1 wherein said toxic metals removed from said storm water runoff by said first and second layers of absorbent materials include aluminum, cadmium, chromium, copper, iron, lead and zinc.

4. The water purification apparatus of claim 1 wherein said first and second layers of absorbent materials comprise a bed of bone char and a bed of activated alumina.

5. The water purification apparatus of claim 4 wherein said bed of bone char has a thickness of one foot, one inch and said bed of activated alumina has a thickness of one foot, eight inches.

6. The water purification apparatus of claim 4 wherein said bed of activated alumina is coated with iron sulfide.

7. The water purification apparatus of claim 1 wherein said first layer of river stone has a thickness of approximately one quarter inch and said second layer of river stone has a thickness of approximately seven inches.

8. The water purification apparatus of claim 1 further comprising first, second and third layers of a geotextile monofilament material located within the interior of said drum structure, wherein the first layer of said geotextile monofilament material is located between said first layer of river stone and said first absorption bed, the second layer of said geotextile monofilament material is located between said first absorption bed and said second absorption bed, and the third layer of said geotextile monofilament material is located between said second absorption bed and said second layer of river stone.

9. The water purification apparatus of claim 1 wherein each of said pair of slotted drainage pipes comprises a three inch diameter PVC pipe having a cap at one end, a female threaded pipe section at the other end and an elbow adjacent the female threaded pipe section which allows a user to adjust said slotted drainage pipe to provide for an approximately two percent downward slope to insure drainage of said clean water from said drum structure.

9. The water purification apparatus of claim 1 wherein said drum structure has a pair of ⅛ inch drainage holes located in a bottom portion of said drum structure.

10. A water purification apparatus for removing toxic metals and metal ions from storm water runoff from a roof top comprising:
(a) a drum structure having an interior and a lid attached to an upper end thereof, wherein the lid of said drum structure includes a centrally located opening for receiving one end of a downspout which transports said storm water runoff from said roof top, wherein said drum structure has a diameter of approximately three feet and a height of approximately four feet and is capable of removing said toxic metals from said storm water runoff at a rate of 12 to 20 gallons per minute;
(b) a strainer basket positioned within the opening in the lid of said drum structure to receive the storm runoff from said roof top, wherein said strainer basket removes large particles of said toxic metals from the storm water runoff entering said drum structure;
(c) a first layer of river stone positioned within the interior of said drum structure below the lid of said drum structure;
(d) first and second absorption beds consisting of first and second layers of absorbent materials stacked one on top of another within the interior of said drum structure below said first layer of river stone, said first and second absorbent materials removing fine particles of said toxic materials and said metal ions from said storm water runoff to provide clean water, wherein said first and second layers of absorbent materials respectively comprise a bed of bone char and a bed of activated alumina;
(e) a second layer of river stone positioned below said first and second layers of absorbent materials to receive the clean water from said first and second layers of absorbent materials;
(f) a pair of slotted drainage pipes positioned parallel to one another within said second layer of river stone, wherein said pair of slotted drainage pipes are slopped downward to allow for drainage of said clean water from said drum structure; and
(g) first, second and third layers of a geotextile monofilament material located within the interior of said drum structure, wherein the first layer of said geotextile monofilament material is located between said first layer of river stone and said first absorption bed, the second layer of said geotextile monofilament material is located between said first absorption bed and said second absorption bed, and the third layer of said geotextile monofilament material is located between said second absorption bed and said second layer of river stone.

11. The water purification apparatus of claim 10 wherein said toxic metals removed from said storm water runoff by said first and second layers of absorbent materials include aluminum, cadmium, chromium, copper, iron, lead and zinc.

12. The water purification apparatus of claim 10 wherein said bed of bone char has a thickness of one foot, one inch and said bed of activated alumina has a thickness of one foot, eight inches.

13. The water purification apparatus of claim 10 wherein said bed of activated alumina is coated with iron sulfide.

14. The water purification apparatus of claim 10 wherein said first layer of river stone has a thickness of approximately one quarter inch and said second layer of river stone has a thickness of approximately seven inches.

15. The water purification apparatus of claim 10 wherein each of said pair of slotted drainage pipes comprises a three inch diameter PVC pipe having a cap at one end, a female threaded pipe section at the other end and an elbow adjacent the female threaded pipe section which allows a user to adjust said slotted drainage pipe to provide for an approximately two percent downward slope to insure drainage of said clean water from said drum structure.

16. The water purification apparatus of claim 10 wherein said drum structure has a pair of ⅛ inch drainage holes located in a bottom portion of said drum structure.

17. A method for removing toxic metal and metal ions from storm water runoff from a roof top comprising the steps:
(a) providing a drum structure having a lid with a centrally located for receiving said storm water runoff including said toxic metal and said metal ions;
(b) transporting said storm water runoff from said roof top to said drum structure located below said roof top, wherein a down spout transports said storm water runoff from said roof top to an opening within the lid of said drum structure;
(c) removing large particles of said toxic metals within said storm water runoff entering said drum structure, wherein a strainer basket positioned within the opening in the lid of said drum structure removes large particles of said toxic metals from the storm water runoff entering said drum structure;
(d) providing a first layer of river stone positioned within the interior of said drum structure below the lid of said drum structure;
(e) providing first and second absorption beds consisting of first and second layers of absorbent materials stacked one on top of another within the interior of said drum structure below said first layer of river stone;
(f) removing fine particles of said toxic materials and said metal ions from said storm water runoff to provide clean water, wherein said first and second layers of absorbent materials remove said fine particles of said toxic materials and said metal ions from said storm water runoff;
(g) providing a second layer of river stone positioned below said first and second layers of absorbent materials to receive the clean water from said first and second layers of absorbent materials;
(h) providing a pair of slotted drainage pipes positioned parallel to one another within said second layer of river stone, wherein said pair of slotted drainage pipes are slopped downward within said rive stone;
(i) draining the clean water from said the interior of said drum structure, wherein the clean water from the interior of said drum structure passes through said pair of slotted drainage pipes to the exterior of said drum structure; and
(j) providing first, second and third layers of a geotextile monofilament material located within the interior of said drum structure, wherein the first layer of said geotextile monofilament material is located between said first layer of river stone and said first absorption bed, the second layer of said geotextile monofilament material is located between said first absorption bed and said second absorption bed, and the third layer of said geotextile monofilament material is located between said second absorption bed and said second layer of river stone.

18. The method of claim 17 wherein said toxic metals removed from said storm water runoff by said first and second layers of absorbent materials include aluminum, cadmium, chromium, copper, iron, lead and zinc.

19. The method of claim 17 wherein said bed of bone char has a thickness of one foot, one inch and said bed of activated alumina has a thickness of one foot, eight inches.

20. The method of claim 17 wherein said bed of activated alumina is coated with iron sulfide.
